(19) United States
(12) Patent Application Publication
(10) Pub. No.: US 2004/0153496 A1
(43) Pub. Date: Aug. 5, 2004

(54) Method for computing a backup path for protecting a working path in a data transport network

(76) Inventors: Peter Ashwood Smith, Gatineau (CA); James A. Shields, Carrickfergus (GB); Evert DeBoer, Nepean (CA)

Correspondence Address: Ralph A. Dowell, DOWELL & DOWELL P.C., Suite 309, 1215 Jefferson Davis Hwy, Arlington, VA, 22202-3124, US

(21) Appl. No.: 10/355,211

(22) Filed: Jan. 31, 2003

(51) Int. Cl. G06F 15/16

(52) U.S. Cl. 709/201

(57) ABSTRACT

A method for computing a backup path for protecting a first working path in a data transport network that includes a plurality of working paths. The method includes determining a route of the backup path by selecting individual backup path segments from a set of possible segments in the data transport network. In the case of a segment that is shared between the first working path and one or more other working paths, the selection process takes into account the existence of a potential point of failure common to the working paths sharing the segment.

### FIELD OF THE INVENTION

The invention relates to a method and to a program element for execution on a computer, to determine a backup path for protecting a working path in a data transport network.

### BACKGROUND OF THE INVENTION

It is common in the art of networking to protect a working path in a data transport network with a backup path. There are several approaches to backup path design. In the most common and reliable form, the backup path is fully established at all times and carries a copy of the data on the working path. A less expensive solution is to have the backup path established at all times but not carrying any data. The data is switched from the working path to the backup path in the event of a failure of the working path. An even less expensive solution is to have the resources for the backup path in a standby mode during the normal operation of the working path. The backup path is allocated and the data switched from the working path only in the event of failure of the working path. Allowing different working paths to use different segments of the backup path can reduce the cost of the backup path even further. Such a solution is often referred to as “backup path with shared segments”.

The adoption of a backup path with a shared segment introduces a risk of inadvertently creating contention between two or more working paths, for the same segment of the backup path, in the event the working paths also share a common potential point of failure. Accordingly, if a failure indeed occurs at that common point, the shared segment on the backup path will not be able to protect the data on all the failed working paths.

Against this background it clearly appears that a need exists to develop a routing method for a backup path with one or more shared segments such as to reduce or eliminate the risk of contention for a segment between two working paths that also share a common potential point of failure.

### SUMMARY OF THE INVENTION

In a first broad aspect, the invention provides a method for computing a backup path for protecting a first working path in a data transport network that includes a plurality of working paths. The method includes determining a route of the backup path by selecting individual backup path segments from a set of possible segments in the data transport network. In the case of a segment that is shared between the first working path and one or more other working paths, the selection process takes into account the existence of a potential point of failure common to the working paths sharing the segment.

The advantage of this method is to provide backup path solutions in which the possibility of contention for a shared segment is reduced between the working paths sharing the segment.

This method can be implemented on a computer.

A common potential point of failure shared by two or more working paths can be any resource, either hardware or software of the data transport network that will cause the working paths to cease functioning if an actual failure occurs at that point. Such resource can be transporting or managing data, such as a port on a network node, a length of optical fiber, electrical conductor or amplifier, among many other possibilities. The resource can also involve components that do not transport or manage data, such as a power supply shared by components via which are established two or more working paths. A failure of the power supply will cause a failure of both working paths.

In one example of implementation of the method, during the selection of the individual segments, any segment shared by two or more working paths that also share a common potential point of failure, is rejected. A more flexible approach is to consider the probability of failure at that common point. If the probability is fairly low, it might be acceptable for some applications to allow the two working paths to share a common segment on a backup path.

In a second broad aspect, the invention provides a computer readable storage medium for holding a program element for execution by a computer to implement the above method.

In a third broad aspect, the invention provides a method for computing a backup path for protecting a working path in a data transport network that includes a plurality of working paths. The method includes computing a tentative backup path through the data transport network, the tentative backup path including a plurality of segments, and ascertaining for one or more segments if the segment is shared by working paths having a common potential point of failure.

### BRIEF DESCRIPTION OF THE DRAWINGS

A detailed description of examples of implementation of the present invention is provided hereinbelow with reference to the following drawings, in which:

FIG. 1 is an example of a data transport network;

FIG. 2 shows the data transport network of FIG. 1 in which a first backup path has been established to protect a first working path;

FIG. 3 shows the data transport network of FIG. 2, illustrating a second backup path for protecting a second working path, sharing several segments with the first backup path, where the two working paths also share a potential point of failure;

FIG. 4 shows the data transport network of FIG. 3, where the second backup path has been re-routed such that it contains no segments shared with the first backup path;

FIG. 5 is a flow chart of the method for computing the backup path; and

FIG. 6 shows the data transport network of FIG. 4, in which is identified a further working path and a backup path.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

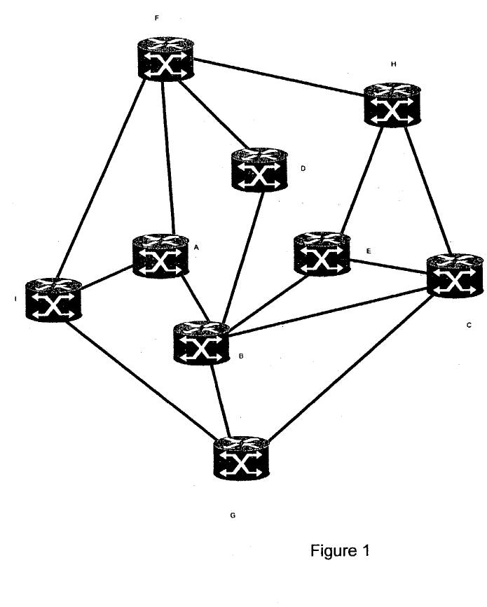

FIG. 1 shows a data transport network in which the present invention can be used. The network includes a plurality of nodes A, B, C, D, E, F, G, H and I connected to one another by links. The links can be of wireless nature or of non-wireless nature. Examples of non-wireless nature links include optical fibers or electrical conductors. Links of wireless nature include Radio Frequency (RF) or Infrared (IR) communication paths, among others.

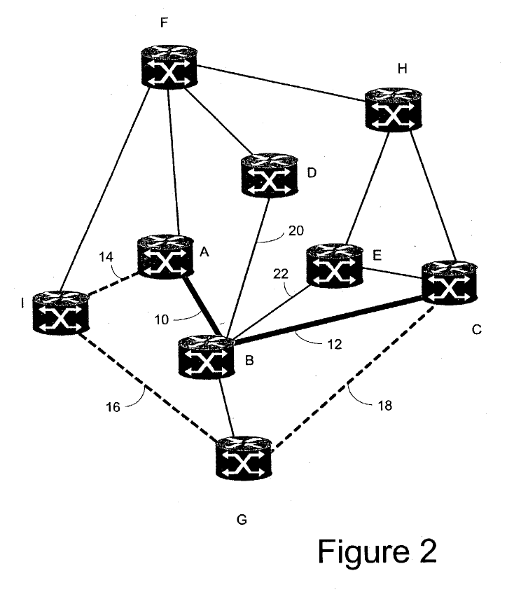

FIG. 2 shows the network of FIG. 1 in which has been established a backup path designed to protect the working path including end node A, link 10, intermediate node B, link 12 and end node C. The backup path shown in stippled lines includes end node A, link 14, node I, link 16, node G, link 18 and end node C. In the event of a failure of the working path A-10-B-12-C, the data will be switched to the backup path A-14-I-16-G-18-C. For clarity, the working path A-10-B-12-C has been identified in FIG. 2 with thicker lines.

It might be desirable to design the protection scheme of the data transport network at FIG. 2 such that one or more segments of the backup path A-14-I-16-G-18-C protect one or more working paths other than the working path A-10-B-12-C. This backup path, therefore, becomes a backup path with shared segments. Note that a backup path with a shared segment is different from a backup path solution in which the backup path is shared in its entirety by other working paths originating and terminating on the same end nodes. A backup path with shared segments includes one or more segments shared by two or more working paths and one or more segments that are not shared by the same group of working paths.

For the purpose of this specification, a segment of a path in the data transport network, either a working path or a backup path, refers to a resource of the data transport network that is used in establishing the path. The resource can be a hardware resource, such as a link of the data transport network between two nodes, a node or components of a node. The resource can also be a software resource.

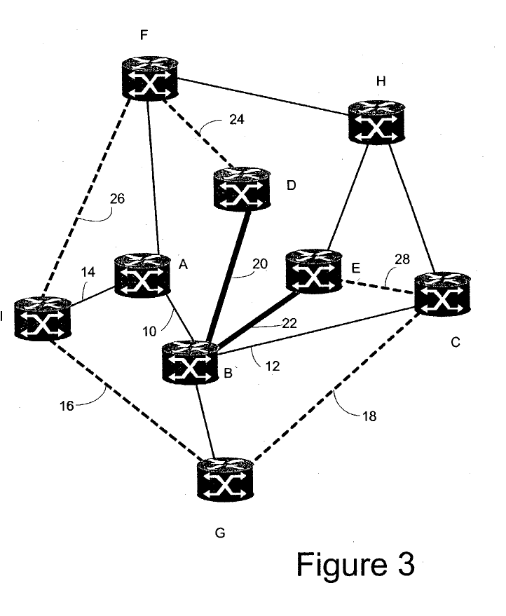

FIG. 3 shows the data transport network of FIG. 1, illustrating in stippled lines a backup path for protecting a different working path, which has an end point at node D, link 20, node B, link 22 and node E. The working path D-20-B-22-E has different endpoints than the working path A-10-B-12-C, however the invention is not limited to this element. In other words, the method can also be used in instances where the working paths sharing one or more segments of the backup path have also common endpoints. The routing of the backup path for protecting the working path D-20-B-22-E is D-24-F-26-I-16-G-18-C-28-E. As discussed in the introductory part of this specification, this protection solution may not be best in light of the fact that both working paths A-10-B-12-C and D-20-B-22-E share a common potential point of failure, which is node B and at the same time both backup paths A-14-I-16-G-18-C and D-24-F-26-I-16-G-18-C-28-E have segments shared by both working paths A-10-B-12-C and D-20-B-22-E. More specifically, the segments I, 16, G, 18 and C are shared segments. In case of failure of node B, a contention will be created between the working paths A-10-B-12-C and D-20-B-22-E for the common segments I, 16, G, 18 and C.

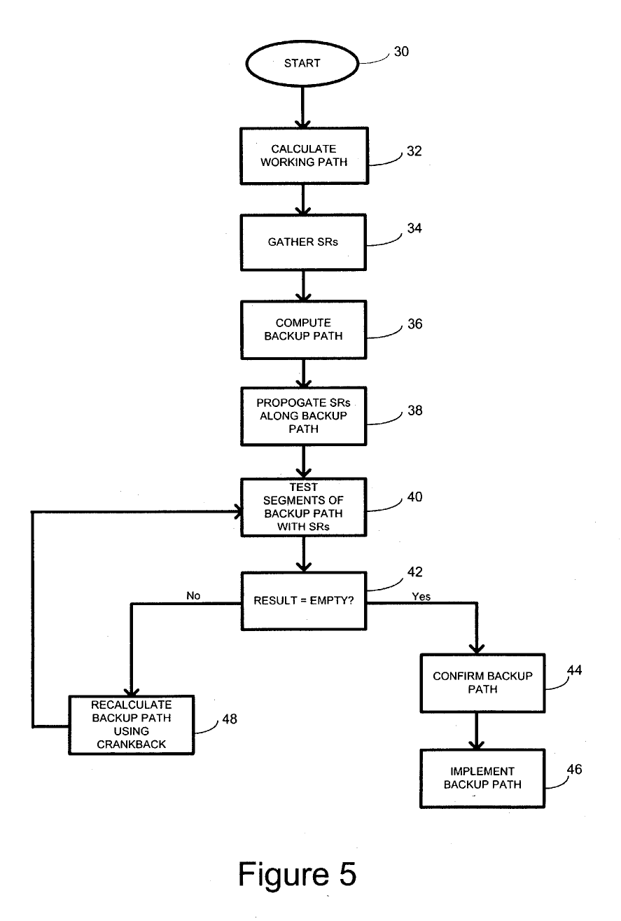

The present invention provides a method for computing a backup path, which has one or more segments shared between different working paths, where the computation takes into account whether the working paths share one or more common potential points of failure, such as to reduce the possibility of contention for the one or more shared segments of the backup path. The method can be implemented on a computer, as it will be described later. A flowchart of one example of implementation of the method is shown at FIG. 5.

The method starts at 30. At the next step 32, a working path is calculated. For the sake of this example, assume that the working path D-20-B-22-E is the path for which a backup path is being sought. Therefore, at step 32 the routing of the working path is calculated. At step 34 the Shared-Risk (SR) values for the working path D-20-B-22-E are gathered. The concept of SRs in data transport networks is known in the area of data transport networks.

Generally, an SR is an identifier that is unique in the data transport network. The SRs are assigned to network resources such that if two resources share a single potential point of failure they are marked with the same SR. For example, if two ports have optical fibers attached to them that use the same amplifier chain, then the SR designating the amplifier chain is added to the set of SRs associated with both ports A and B. The concept of SR is commonly used in the art to avoid setting up working and backup paths that share one or more potential points of failure.

Once the SRs of the working path D-20-B-22-E have been gathered, a tentative backup path is computed at step 36. As indicated earlier, the tentative backup path is computed such that it does not share any SRs of the working path D-20-B-22-E by any of a number of different algorithms available in the literature, such as a Dikjstra type computation algorithm over colored graphs. For the sake of this example, assume that the tentative backup path D-24-F-26-I-16-G-18-C-28-E (shown at FIG. 3) is computed.

At step 38, the SRs of the working path D-20-B-22-E are added to the set of SRs of each segment of the tentative backup path D-24-F-26-I-16-G-18-C-28-E. At step 40, the method tests the tentative backup path D-24-F-26-I-16-G-18-C-28-E to determine if it contains any segments shared by working paths that also share one or more potential point of failure. This is effected by intersecting the SRs of the working path D-20-B-22-E with the SRs of each segment of the tentative backup path D-24-F-26-I-16-G-18-C-28-E. For each segment, this is equivalent of intersecting the SRs of the working path with the SRs of every other working path that may also be sharing the segment. If the result of this intersection is empty (answer “yes” to conditional step 42), then one can conclude that working paths that also share a potential point of failure do not share this particular segment of the tentative backup path. If the result of the intersection is empty, the tentative backup path is confirmed at step 44 and at step 46 the backup path is actually implemented by setting the necessary hardware and software resources of the data transport network such that if the working path fails, the data from the working path will be switched to the backup path.

In the specific example of working path D-20-B-22-E and tentative backup path D-24-F-26-I-16-G-18-C-28-E the result of the test at step 42 will not be empty. The SRs of any one of the segments I, 16, G, 18 and C will all positively intersect with the SRs of the working path D-20-B-22-E since they all contain a common risk which is the node B. Accordingly, the conditional step 42 will be answered in the negative for each segment I, 16, G, 18 and C. The method then branches to step 48 at which a crankback process is implemented to correct the conflict. The crankback process goes back to a segment preceding the segment at which the intersection was positive and a new tentative backup path is computed from that point by excluding any one of the conflict segments. The process is repeated if needed in the case the newly computed tentative backup path still contains conflict segments.

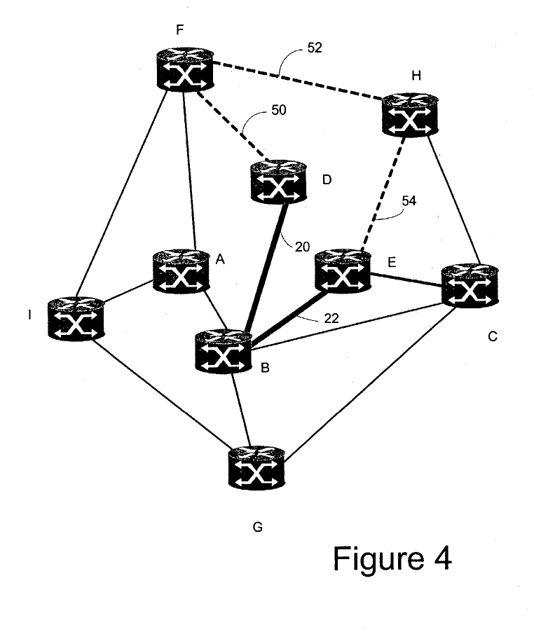

FIG. 4 illustrates the crankback process in connection with working path D-20-B-22-E. The first conflict segment on old tentative backup path D-24-F-26-I-16-G-18-C-28-E is segment I. The crankback process then attempts to compute a new tentative backup path starting at segment F while excluding segments I, 16, G, 18 and C. A new tentative backup path D-50-F-52-H-54-E is computed and tested again by returning to step 40.

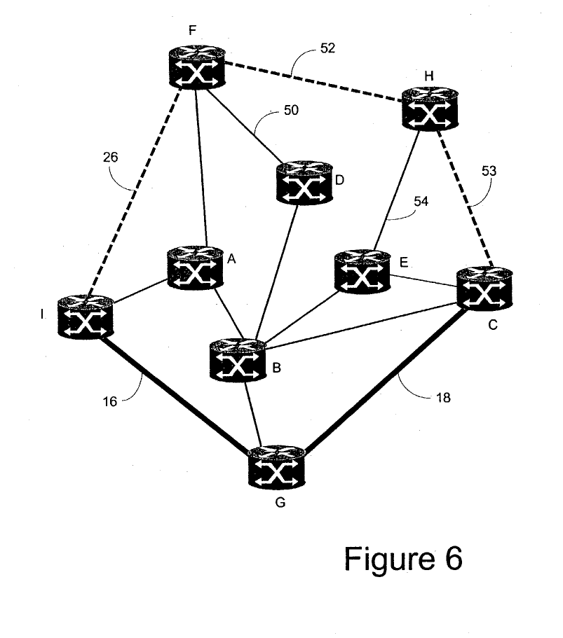

FIG. 6 illustrates the situation where another working path, path I-16-G-18-C uses backup path I-26-F-52-H-53-C. The backup path I-26-F-52-H-53-C and the tentative backup path D-50-F-52-H-54-E share segments F, 52 and H but the working paths corresponding to those backup paths share no potential point of failure.

Therefore, since no conflict segments exist in the tentative backup path D-50-F-52-H-54-E, that backup path is confirmed at step 42 and then implemented at step 46.

The method described above aims to avoid implementation of backup paths with segments shared among working paths that have a common potential point of failure. A possible refinement to this process is to take into account the actual probability of failure at a common point shared by two or more working paths in deciding if it is acceptable to deploy a backup path with a segment shared between these two or more working paths. Since the probability of failure at a certain common point may vary depending on the type of hardware or software used at that location, the risk of contention for a shared segment between two working paths also sharing that same point, will be related to the common point probabililty of failure. If the common point is highly unlikely to fail, it may be acceptable to allow working paths sharing that common point to also share a common segment on a backup path. A possible approach to implement this variant is to consider each time a positive intersection between sets of SRs is observed (step 42 answered in the affirmative) a probability of failure at the common point (allocated by the data transport network operator or otherwise) and accept the segment if the probability is below a certain level or reject the segment if the probability is above the level.

The method described above can be implemented on a computer. More specifically, a program element with functional blocks corresponding to the various steps of the process is stored on a computer readable storage medium. The program element is executable by a processor of the computer to implement the method.

Although various embodiments have been illustrated, this was for the purpose of describing, but not limiting, the invention. Various modifications will become apparent to those skilled in the art and are within the scope of this invention, which is defined more particularly by the attached claims.

1) A method for computing a backup path for protecting a first working path in a data transport network that includes a plurality of working paths, the method comprising:
a) determining a backup path through the data transport network by selecting segments of the backup path from a set of available segments in the data transport network, where at least one of the selected segments is a shared segment part of a backup path protecting a second working path other than the first working path;
b) the selecting of the shared segment including determining if the first and second working paths have a common potential point of failure.

2) A method as defined in claim 1, wherein the point of failure includes a component of the data transport network conveying data.

3) A method as defined in claim 2, wherein at least one of the selected segments is for protection of the first working path but not for the protection of the second working path.

4) A method as defined in claim 3, wherein the first working path and the second working path have different endpoints.

5) A method as defined in claim 4, including selecting a given segment from the set of available segments in the data transport network as part of the backup path if working paths sharing the given segment are free of a common potential point of failure.

6) A method as defined in claim 4, wherein if the first and second working paths include a common potential point of failure, the selecting includes assessing a probability of failure at the common potential point of failure.

7) A method for computing a backup path for protecting a first working path in a data transport network that includes a plurality of working paths, the method comprising:
a) computing a tentative backup path through the data transport network the tentative backup path including a plurality of segments;
b) ascertaining for one or more segments if the segment is shared by working paths having a common potential point of failure.

8) A method as defined in claim 7, wherein the point of failure includes a component of the data transport network conveying data.

9) A method as defined in claim 8, wherein if a segment is identified in the tentative backup path as shared by working paths having a common potential point of failure, the method includes computing a new tentative backup path.

10) A method as defined in claim 9, wherein the method includes ascertaining for each segment of the new tentative backup path if the segment is shared by working paths having a common potential point of failure.

11) A method as defined in claim 10, wherein if no segment is found in the new tentative backup path that is shared by working paths having a common potential point of failure, implementing the backup path.

12) A computer readable storage medium containing a program element for execution by a computer to implement a method for computing a backup path for protecting a first working path in a data transport network that includes a plurality of working paths, the method comprising:
a) determining a backup path through the data transport network by selecting segments of the backup path from a set of available segments in the data transport network, where at least one of the selected segments is a shared segment part of a backup path protecting a second working path other than the first working path;
b) the selecting of the shared segment including determining if the first and second working paths have a common potential point of failure.

13) A computer readable storage medium as defined in claim 12, wherein the point of failure includes a component of the data transport network conveying data.

14) A computer readable storage medium as defined in claim 13, wherein at least one of the selected segments is for protection of the first working path but not for the protection of the second working path.

15) A computer readable storage medium as defined in claim 14, wherein the first working path and the second working path have different endpoints.

16) A computer readable storage medium as defined in claim 15, including selecting a given segment from the set of available segments in the data transport network as part of the backup path if working paths sharing the given segment are free of a common potential point of failure.

17) A computer readable storage medium as defined in claim 16, wherein if the first and second working paths include a common potential point of failure, the selecting includes assessing a probability of failure at the common potential point of failure.

18) A computer readable storage medium as defined in claim 16, including:
a) computing a tentative backup path including a plurality of segments;
b) ascertaining for each segment if the segment is shared by working paths having a common potential point of failure.

19) A computer readable storage medium as defined in claim 18, wherein if a segment is identified in the tentative backup path shared by working paths having a common potential point of failure, the method includes computing a new tentative backup path.

20) A computer readable storage medium as defined in claim 19, wherein the method includes ascertaining for each segment of the new tentative backup path if the segment if the segment is shared by working paths having a common potential point of failure.

21) A computer readable storage medium as defined in claim 20, wherein if no segment is found in the new tentative backup path that is shared by working paths having a common potential point of failure, implementing the backup path.
